(19) United States
(12) Patent Application Publication
(10) Pub. No.: US 2018/0220274 A1
(43) Pub. Date: Aug. 2, 2018

(54) Systems, Devices, and/or Methods for Managing Emergency Communications

(71) Applicant: Zihan Chen, Charlottesville, VA (US)

(72) Inventor: Zihan Chen, Charlottesville, VA (US)

(21) Appl. No.: 15/420,327

(22) Filed: Jan. 31, 2017

(51) Int. Cl. H04W 4/22; H04W 4/12; H04M 1/725

(52) U.S. Cl. CPC H04W 4/22; H04M 1/72563; H04W 4/12

(57) ABSTRACT

Certain exemplary embodiments can provide a communication device comprising a plurality of active components. Each of the plurality of active components can have a function when pressed individually that is not directed toward placement of any call. The communication device can comprise machine instructions that recognize that a user has pressed a predetermined pattern of one or more of the plurality of active components and, responsive to recognizing the predetermined pattern of one or more of the plurality of active components have been pressed, performs a predetermined function.

### BRIEF DESCRIPTION OF THE DRAWINGS

A wide variety of potential practical and useful embodiments will be more readily understood through the following detailed description of certain exemplary embodiments, with reference to the accompanying exemplary drawings in which:

FIG. 1 is a perspective view of an exemplary embodiment of a communication device 1000;

FIG. 2 is a top view of an exemplary embodiment of a communication device 1000;

FIG. 3 is a side view of an exemplary embodiment of a communication device 1000;

FIG. 4 is a block diagram of an exemplary embodiment of a system 4000;

FIG. 5 is a flowchart of an exemplary embodiment of a method 5000; and

FIG. 6 is a block diagram of an exemplary embodiment of an information device 6000.

### DETAILED DESCRIPTION

Certain exemplary embodiments can provide a communication device comprising a plurality of active components. Each of the plurality of active components can have a function when pressed individually that is not directed toward placement of any call. The communication device can comprise machine instructions that recognize that a user has pressed a predetermined pattern of one or more of the plurality of active components and, responsive to recognizing the predetermined pattern of one or more of the plurality of active components have been pressed, performs a predetermined function.

Communication device (e.g., smartphone) users might have occasions where it can be important to be able to perform certain functions quickly. For example, in emergency situations, a user might want to communicate quickly with an emergency services provider (e.g., a 911 operator) without having to pull a virtual keypad up, press the numbers for a call, and touching an icon to connect a call. In such circumstances, the user might find it preferable to be able to touch a predetermined pattern of one or more of a plurality of active components of the communication device in order to connect such a call or perform some other desired function. For example, in certain exemplary embodiments, a user might simultaneously press a home button and a communication device speaker volume control button for in excess of a predetermined time (e.g., approximately two seconds), application software in the communication device can recognize such as a request to make a call to the emergency services provider.

Certain exemplary communication devices can provide software that allow a user to associate touches a pattern of active components with a certain desired action. The pattern can involve a sequence of touches and/or a set of active components that are touched simultaneously for a predetermined time period. By using such software, the user can define a plurality of predetermined patterns recognized by the machine instructions and causing a unique predetermined response associated with each predetermined pattern of the plurality of predetermined patterns. Thereby, the user can customize the communication device for efficient performance of functions compared to basic communication devices without such functionality.

In certain exemplary embodiments, a communication device can comprise a button, which can be “regularly” pressed as to press and release. The button can be pressed and held to perform a different function. For example, when using an app on an iPhone (iPhone is a registered trademark of Apple Inc. of Cupertino Calif.), a user can press the home button to exit to a main screen. The user can press and hold the home button to call virtual assistant Siri (Siri is a registered trademark of Apple Inc. of Cupertino Calif.).

An exemplary communication device can comprise many active components. For example, the communication device can comprise buttons, switches, and/or active touch areas. The active components can comprise components that function as an device on/off, volume control, scroll lock, device home, and/or volume mute, etc.

Certain exemplary methods disclosed herein can be invoked when a user invokes more than one active component simultaneously. For example, a predetermined action can be invoked by:
toggling a mute switch continuously for 5 times with a frequency higher than a predetermined frequency;
   holding a power button and a volume button simultaneously for a predetermined time period; and/or
   pressing a power button and a volume button simultaneously for a predetermined time period and repeating that action for a predetermined count of times; etc.

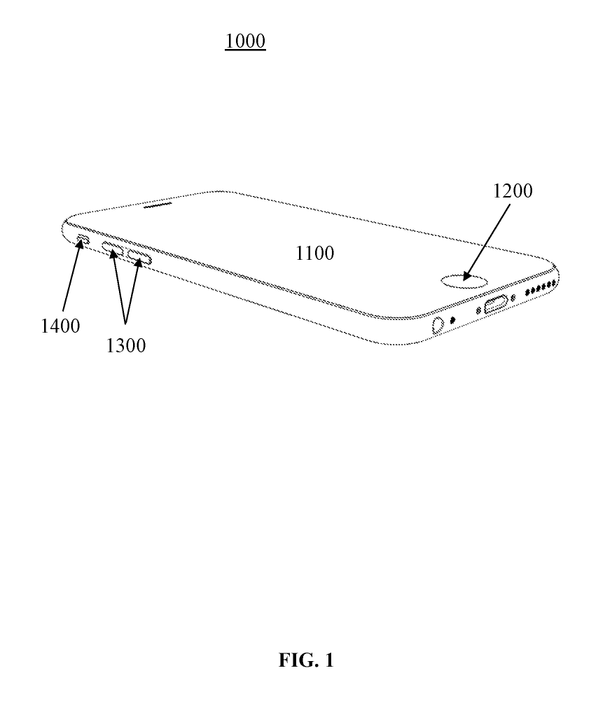

FIG. 1 is a perspective view of an exemplary embodiment of a communication device 1000, which can comprising a plurality of active components. Communication device 1000 can be a smartphone such as an iPhone and/or a smartphone made by Acer, Alcatel, Allview, Amazon, Amoi, Archos, Asus, AT&T, Benefon, Benq, Benq-Siemens, Bird, Blackberry, Blu, Bosch, Bq, Casio, Cat, Celkon, Chea, Coolpad, Dell, Emporia, Energizer, Ericsson, Eten, Fujitsu Siemens, Garmin-Asus, Gigabyte, Gionee, Google, Haier, HP, HTC, Huawei, I-Mate, I-Mobile, Icemobile, Innostream, Inq, Intex, Jolla, Karbonn, Kyocera, Lava, Leeco, Lenovo, LG, Maxon, Maxwest, Meizu, Micromax, Microsoft, Mitac, Mitsubishi, Modu, Motorola, MWG, NEC, Neonode, NIU, Nokia, Nvidia, O2, Oneplus, Oppo, Orange, Palm, Panasonic, Pantech, Parla, Philips, Plum, Posh, Prestigio, QMobile, Qtek, Sagem, Samsung, Sendo, Sewon, Sharp, Siemens, Sonim, Sony, Sony Ericsson, Spice, T-Mobile, Tel.Me., Telit, Thuraya, Toshiba, Unnecto, Vertu, Verykool, Vivo, Vk Mobile, Vodafone, Wiko, WND, Xcute, Xizomi, Xolo, Yezz, Yota, YU, and/or Zte, etc.

As examples, the active components can comprise a touchscreen 1100, a home button 1200, a set of volume control buttons 1300, a mute switch 1400, and/or other buttons and switches, etc. Each of the plurality of active components has a function when invoked individually that is not directed toward placement of any call. For example, communication device 1000 can place calls via a virtual keypad rendered on touchscreen 1100. Communication device 1000 can comprise machine instructions that recognize that a user has invoked a predetermined pattern of one or more of the plurality of active components and, responsive to recognizing the predetermined pattern of one or more of the plurality of active components have been invoked, performs a predetermined function. The predetermined function can be selected from:
placing a call to a first predetermined receiver, wherein the call to the first predetermined receiver is placed without the user acting further other than invoking the predetermined pattern of one or more of the plurality of active components;
   the predetermined receiver can be an emergency services provider;
collecting data, the data comprising at least one of location data, sound data, and image data, wherein the data is collected without the user acting further other than invoking the predetermined pattern of one or more of the plurality of active components;
transmitting data to a second predetermined receiver, wherein the data is transferred without the user acting further other than invoking the predetermined pattern of one or more of the plurality of active components; and/or
transmitting a predetermined message to a third predetermined receiver, the predetermined message can be a message that transmits data about the user, wherein the predetermined message is sent:
   wirelessly; and/or
   without the user acting further other than invoking the predetermined pattern of one or more of the plurality of active components.

The predetermined pattern of one or more of the plurality of active components can be one of a plurality of predetermined patterns of the one or more of the plurality of active components, each of the plurality of predetermined patterns can be recognized by the machine instructions and causing a predetermined response. In certain exemplary embodiments, the user can define at least one of the plurality of predetermined patterns. In certain exemplary embodiments, the user can change at least one of the plurality of predetermined patterns.

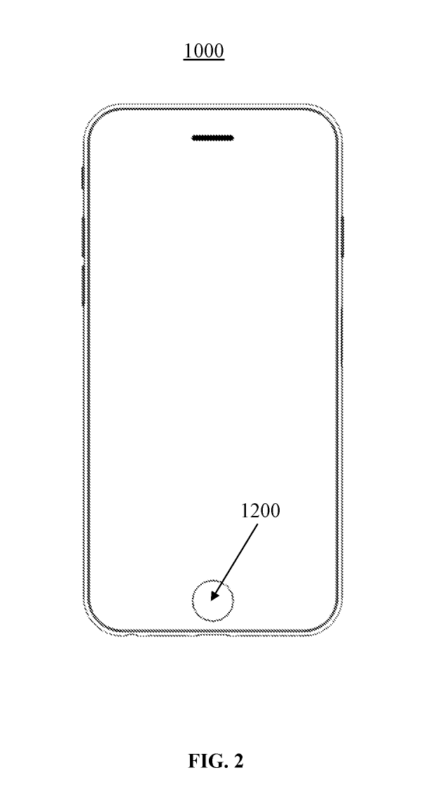

FIG. 2 is a top view of an exemplary embodiment of communication device 1000.

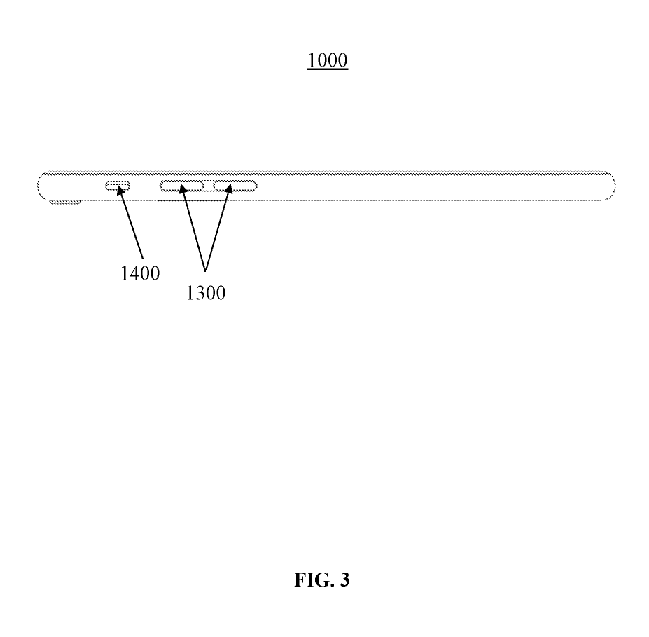

FIG. 3 is a side view of an exemplary embodiment of communication device 1000.

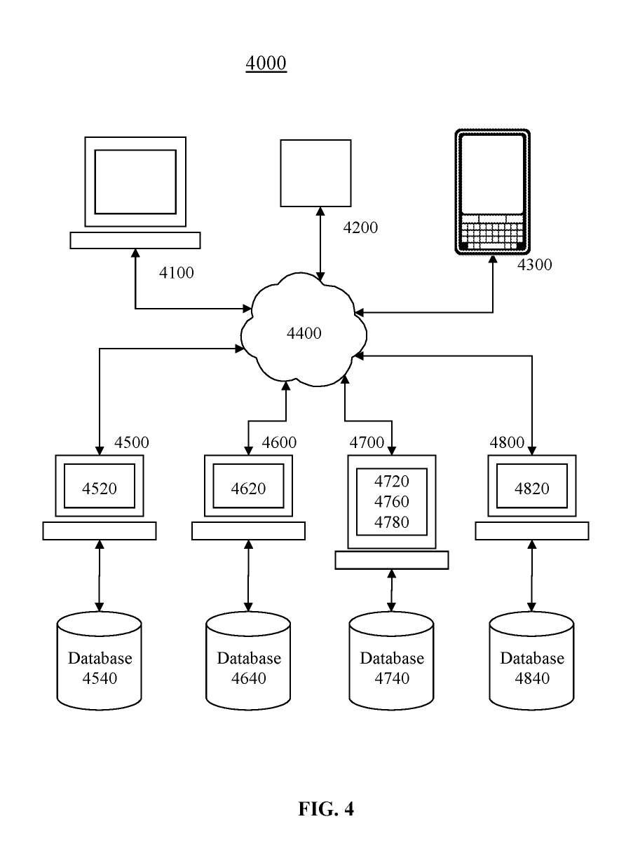

FIG. 4 is a block diagram of an exemplary embodiment of a system 4000, which can comprise a communication device 4300, an information device 4100, a network 4400, a first server 4500, a second server 4600, a third server 4700, and a fourth server 4800. First server 4500 can comprise a first user interface 4520 and can be coupled to a first database 4540. Second server 4600 can comprise a second user interface 4620 and can be coupled to a second database 4640. Third server 4700 can comprise a third user interface 4720, a processor 4760, machine instructions 4780, and can be coupled to a third database 4740. Fourth server 4800 can comprise a fourth user interface 4820 and can be coupled to a fourth database 4840. Any of the methods and/or steps thereof can be carried out in whole or in part by communication device 4300, information device 4100 and/or first server 4500. Second server 4600, third server 4700, and/or fourth server 4800 can each be associated with administration and allocation of patient treatment resources by a medical treatment facility, such as a hospital, supporting data for which is stored in memory devices coupled thereto. In certain exemplary embodiments, system 4000 can be used to implement one or more methods disclosed herein.

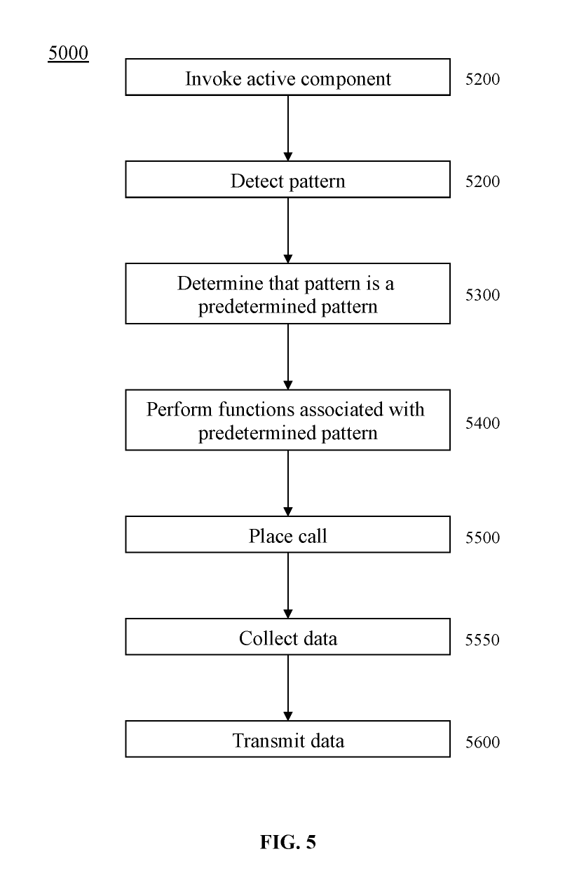

FIG. 5 is a flowchart of an exemplary embodiment of a method 5000. At activity 5100, an active component of a communication device can be invoked by a user. At activity 5200, a pattern of invocation of active components can be detected. At activity 5300, a determination (e.g., an automatic determination) can be made that the detected pattern is a predetermined pattern, which can be one of a plurality of predetermined patterns. At activity 5400, functions can be performed that are associated with the predetermined pattern. At activity 5500, a call can be placed. In certain exemplary embodiments, the call can be placed to an emergency services provider from the communication device. The call placed responsive to the automatic determination that a user has invoked a predetermined pattern of one or more of a plurality of active components comprised by the communication device. The call to the emergency services provider can be placed without the user acting further other than invoking the predetermined pattern of one or more of the plurality of active components. Wherein, each of the plurality of active components has a function when invoked individually that is not directed toward placement of any call.

At activity 5600, data can be transmitted responsive to a determination that the predetermined pattern is a predetermined pattern that indicates the transmission of data.

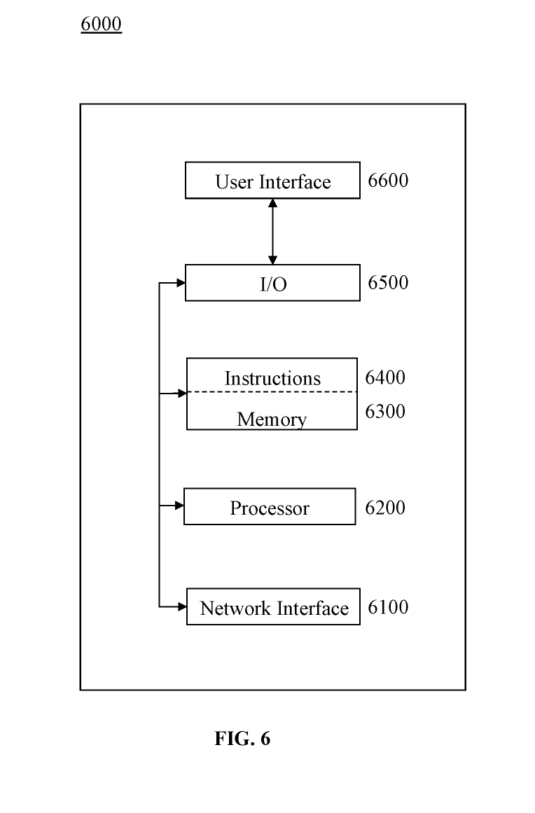

FIG. 6 is a block diagram of an exemplary embodiment of an information device 6000, which in certain operative embodiments can comprise, for example, first server 4500 and information device 4100, of FIG. 4. Information device 6000 can comprise any of numerous circuits and/or components, such as for example, one or more network interfaces 6100, one or more processors 6200, one or more memories 6300 containing instructions 6400, one or more of an input/output (“I/O”) device 6500, and/or one or more user interfaces 8600 coupled to I/O device 6500, etc.

In certain exemplary embodiments, via one or more user interfaces 6600, such as a graphical user interface, a user can view a rendering of information related to utilization of a communication device that is constructed and/or programmed to perform functionality of devices, systems, and/or methods described herein.

### Definitions

When the following terms are used substantively herein, the accompanying definitions apply. These terms and definitions are presented without prejudice, and, consistent with the application, the right to redefine these terms during the prosecution of this application or any application claiming priority hereto is reserved. For the purpose of interpreting a claim of any patent that claims priority hereto, each definition (or redefined term if an original definition was amended during the prosecution of that patent), functions as a clear and unambiguous disavowal of the subject matter outside of that definition.
a—at least one.
acting further—doing more than a predetermined pattern of actions.
active component—a knob, button, disk, switch, a touch sensitive surface, or a touch screen portion of a communication device that is touched or moved to activate or control an electronic circuit.
activity—an action, act, step, and/or process or portion thereof.
and/or—either in conjunction with or in alternative to.
apparatus—an appliance or device for a particular purpose
associate—to join, connect together, and/or relate.
automatically—acting or operating in a manner essentially independent of external influence or control. For example, an automatic light switch can turn on upon “seeing” a person in its view, without the person manually operating the light switch.
can—is capable of, in at least some embodiments.
cause—to produce an effect.
circuit—an electrically conductive pathway and/or a communications connection established across two or more switching devices comprised by a network and between corresponding end systems connected to, but not comprised by the network.
collect—to detect and store.
communication device—a device that is capable of sending signals to and/or receiving signals from another device such that a message is exchanged between the devices via the signals.
comprising—including but not limited to.
configure—to make suitable or fit for a specific use or situation.
constructed to—made to and/or designed to.
convert—to transform, adapt, and/or change.
couple—to join, connect, and/or link together.
create—to bring into being.
data—distinct pieces of information, usually formatted in a special or predetermined way and/or organized to express concepts.
data structure—an organization of a collection of data that allows the data to be manipulated effectively and/or a logical relationship among data elements that is designed to support specific data manipulation functions. A data structure can comprise metadata to describe the properties of the data structure. Examples of data structures can include: array, dictionary, graph, hash, heap, linked list, matrix, object, queue, ring, stack, tree, and/or vector.
define—to establish the outline, form, or structure of
detect—automatically sense.
determine—to obtain, calculate, decide, deduce, and/or ascertain.
device—a machine, manufacture, and/or collection thereof.
emergency service provider—an entity that directly and/or indirectly provides emergency services under circumstances that require prompt action. Emergency services comprise an emergency services dispatcher (e.g., an operator answering a “911” call), medical care, transport to medical care, police services, and/or fire department services.
estimate—to calculate and/or determine approximately and/or tentatively.
function—an predetermined action.
generate—to create, produce, give rise to, and/or bring into existence.
haptic—involving the human sense of kinesthetic movement and/or the human sense of touch. Among the many potential haptic experiences are numerous sensations, body-positional differences in sensations, and time-based changes in sensations that are perceived at least partially in non-visual, non-audible, and non-olfactory manners, including the experiences of tactile touch (being touched), active touch, grasping, pressure, friction, traction, slip, stretch, force, torque, impact, puncture, vibration, motion, acceleration, jerk, pulse, orientation, limb position, gravity, texture, gap, recess, viscosity, pain, itch, moisture, temperature, thermal conductivity, and thermal capacity.
image—a sensed and/or photographed set of data that represents a physical likeness of something.
individually—alone without any other.
information device—any device capable of processing data and/or information, such as any general purpose and/or special purpose computer, such as a personal computer, workstation, server, minicomputer, mainframe, supercomputer, computer terminal, laptop, wearable computer, and/or Personal Digital Assistant (PDA), mobile terminal, Bluetooth device, communicator, “smart” phone (such as a Treo-like device), messaging service (e.g., Blackberry) receiver, pager, facsimile, cellular telephone, a traditional telephone, telephonic device, a programmed microprocessor or microcontroller and/or peripheral integrated circuit elements, an ASIC or other integrated circuit, a hardware electronic logic circuit such as a discrete element circuit, and/or a programmable logic device such as a PLD, PLA, FPGA, or PAL, or the like, etc. In general any device on which resides a finite state machine capable of implementing at least a portion of a method, structure, and/or or graphical user interface described herein may be used as an information device. An information device can comprise components such as one or more network interfaces, one or more processors, one or more memories containing instructions, and/or one or more input/output (I/O) devices, one or more user interfaces coupled to an I/O device, etc.
initialize—to prepare something for use and/or some future event.
input/output (I/O) device—any sensory-oriented input and/or output device, such as an audio, visual, haptic, olfactory, and/or taste-oriented device, including, for example, a monitor, display, projector, overhead display, keyboard, keypad, mouse, trackball, joystick, gamepad, wheel, touchpad, touch panel, pointing device, microphone, speaker, video camera, camera, scanner, printer, haptic device, vibrator, tactile simulator, and/or tactile pad, potentially including a port to which an I/O device can be attached or connected.
invoke—to put into use via human touch.
iPhone—a particular brand and model of smartphone produced by Apple Inc. of Cupertino, Calif.
location—a physical place.
machine instructions—directions adapted to cause a machine, such as an information device, to perform one or more particular activities, operations, or functions. The directions, which can sometimes form an entity called a “processor”, “kernel”, “operating system”, “program”, “application”, “utility”, “subroutine”, “script”, “macro”, “file”, “project”, “module”, “library”, “class”, and/or “object”, etc., can be embodied as machine code, source code, object code, compiled code, assembled code, interpretable code, and/or executable code, etc., in hardware, firmware, and/or software.
machine readable medium—a physical structure from which a machine can obtain data and/or information. Examples include a memory, punch cards, etc.
may—is allowed and/or permitted to, in at least some embodiments.
memory device—an apparatus capable of storing analog or digital information, such as instructions and/or data. Examples include a non-volatile memory, volatile memory, Random Access Memory, RAM, Read Only Memory, ROM, flash memory, magnetic media, a hard disk, a floppy disk, a magnetic tape, an optical media, an optical disk, a compact disk, a CD, a digital versatile disk, a DVD, and/or a raid array, etc. The memory device can be coupled to a processor and/or can store instructions adapted to be executed by processor, such as according to an embodiment disclosed herein.
method—a process, procedure, and/or collection of related activities for accomplishing something.
network—a communicatively coupled plurality of nodes. A network can be and/or utilize any of a wide variety of sub-networks, such as a circuit switched, public-switched, packet switched, data, telephone, telecommunications, video distribution, cable, terrestrial, broadcast, satellite, broadband, corporate, global, national, regional, wide area, backbone, packet-switched TCP/IP, Fast Ethernet, Token Ring, public Internet, private, ATM, multi-domain, and/or multi-zone sub-network, one or more Internet service providers, and/or one or more information devices, such as a switch, router, and/or gateway not directly connected to a local area network, etc.
network interface—any device, system, or subsystem capable of coupling an information device to a network. For example, a network interface can be a telephone, cellular phone, cellular modem, telephone data modem, fax modem, wireless transceiver, Ethernet card, cable modem, digital subscriber line interface, bridge, hub, router, or other similar device.
not directed toward placement of any call—doing something substantially other than coupling communications devices for voice communications.
packet—a discrete instance of communication.
pattern—two or more actions involving at least one active component of a communication device.
place a call—to communicatively couple two or more communication devices such that a voice communication can take place.
plurality—the state of being plural and/or more than one.
predetermined—established in advance.
press—to push against.
processor—a device and/or pattern of machine-readable instructions for performing one or more predetermined tasks. A processor can comprise any one or a combination of hardware, firmware, and/or software. A processor can utilize mechanical, pneumatic, hydraulic, electrical, magnetic, optical, informational, chemical, and/or biological principles, signals, and/or inputs to perform the task(s). In certain embodiments, a processor can act upon information by manipulating, analyzing, modifying, converting, transmitting the information for use by an executable procedure and/or an information device, and/or routing the information to an output device. A processor can function as a central processing unit, local controller, remote controller, parallel controller, and/or distributed controller, etc. Unless stated otherwise, the processor can be a general-purpose device, such as a microcontroller and/or a microprocessor, such the Pentium IV series of microprocessor manufactured by the Intel Corporation of Santa Clara, Calif. In certain embodiments, the processor can be dedicated purpose device, such as an Application Specific Integrated Circuit (ASIC) or a Field Programmable Gate Array (FPGA) that has been designed to implement in its hardware and/or firmware at least a part of an embodiment disclosed herein.
project—to calculate, estimate, or predict.
provide—to furnish, supply, give, and/or make available.
receive—to get as a signal, take, acquire, and/or obtain.
receiver—a device and/or system that receives a signal from a communication device.
recognize—to identify via an electronic circuit or machine instructions.
recommend—to suggest, praise, commend, and/or endorse.
render—to make perceptible to a human, for example as data, commands, text, graphics, audio, video, animation, and/or hyperlinks, etc., such as via any visual, audio, and/or haptic means, such as via a display, monitor, electric paper, ocular implant, cochlear implant, speaker, etc.
repeatedly—again and again; repetitively.
request—to express a desire for and/or ask for.
responsive to—occurring as a direct result of.
select—to make a choice or selection from alternatives.
set—a related plurality.
signal—information, such as machine instructions for activities and/or one or more letters, words, characters, symbols, signal flags, visual displays, and/or special sounds, etc. having prearranged meaning, encoded as automatically detectable variations in a physical variable, such as a pneumatic, hydraulic, acoustic, fluidic, mechanical, electrical, magnetic, optical, chemical, and/or biological variable, such as power, energy, pressure, flowrate, viscosity, density, torque, impact, force, frequency, phase, voltage, current, resistance, magnetomotive force, magnetic field intensity, magnetic field flux, magnetic flux density, reluctance, permeability, index of refraction, optical wavelength, polarization, reflectance, transmittance, phase shift, concentration, and/or temperature, etc. Depending on the context, a signal and/or the information encoded therein can be synchronous, asynchronous, hard real-time, soft real-time, non-real time, continuously generated, continuously varying, analog, discretely generated, discretely varying, quantized, digital, broadcast, multicast, unicast, transmitted, conveyed, received, continuously measured, discretely measured, processed, encoded, encrypted, multiplexed, modulated, spread, de-spread, demodulated, detected, de-multiplexed, decrypted, and/or decoded, etc.
smartphone—a mobile phone (also known as cell phones) with an advanced mobile operating system that combines features of a personal computer operating system with other features useful for mobile or handheld use. Smartphones, combine the features of a mobile phone, such as the abilities to place and receive voice calls and create and receive text messages, with those of other popular digital mobile devices like personal digital assistants (PDAs), such as an event calendar, media player, video games, GPS navigation, digital camera, and/or digital video camera, etc. Smartphones can access the Internet and can run a variety of third-party software components (“apps”). Smartphones have a user interface that comprises a touchscreen, which enables the user to use a virtual keyboard to type words and numbers and press onscreen icons to activate “app” features.
sound—a periodic disturbance in the pressure or density of a fluid or in the elastic strain of a solid, produced by a vibrating object. Sound has a velocity in air at sea level at 0° C. of approximately 331 meters per second (approximately miles per hour) and travels as longitudinal waves.
store—to place, hold, and/or retain data, typically in a memory.
substantially—to a great extent or degree.
system—a collection of mechanisms, devices, machines, articles of manufacture, processes, data, and/or instructions, the collection designed to perform one or more specific functions.
transmit—to send as a signal, provide, furnish, and/or supply.
user—a person that controls a communication device.
user interface—any device for rendering information to a user and/or requesting information from the user. A user interface includes at least one of textual, graphical, audio, video, animation, and/or haptic elements. A textual element can be provided, for example, by a printer, monitor, display, projector, etc. A graphical element can be provided, for example, via a monitor, display, projector, and/or visual indication device, such as a light, flag, beacon, etc. An audio element can be provided, for example, via a speaker, microphone, and/or other sound generating and/or receiving device. A video element or animation element can be provided, for example, via a monitor, display, projector, and/or other visual device. A haptic element can be provided, for example, via a very low frequency speaker, vibrator, tactile stimulator, tactile pad, simulator, keyboard, keypad, mouse, trackball, joystick, gamepad, wheel, touchpad, touch panel, pointing device, and/or other haptic device, etc. A user interface can include one or more textual elements such as, for example, one or more letters, number, symbols, etc. A user interface can include one or more graphical elements such as, for example, an image, photograph, drawing, icon, window, title bar, panel, sheet, tab, drawer, matrix, table, form, calendar, outline view, frame, dialog box, static text, text box, list, pick list, pop-up list, pull-down list, menu, tool bar, dock, check box, radio button, hyperlink, browser, button, control, palette, preview panel, color wheel, dial, slider, scroll bar, cursor, status bar, stepper, and/or progress indicator, etc. A textual and/or graphical element can be used for selecting, programming, adjusting, changing, specifying, etc. an appearance, background color, background style, border style, border thickness, foreground color, font, font style, font size, alignment, line spacing, indent, maximum data length, validation, query, cursor type, pointer type, autosizing, position, and/or dimension, etc. A user interface can include one or more audio elements such as, for example, a volume control, pitch control, speed control, voice selector, and/or one or more elements for controlling audio play, speed, pause, fast forward, reverse, etc. A user interface can include one or more video elements such as, for example, elements controlling video play, speed, pause, fast forward, reverse, zoom-in, zoom-out, rotate, and/or tilt, etc. A user interface can include one or more animation elements such as, for example, elements controlling animation play, pause, fast forward, reverse, zoom-in, zoom-out, rotate, tilt, color, intensity, speed, frequency, appearance, etc. A user interface can include one or more haptic elements such as, for example, elements utilizing tactile stimulus, force, pressure, vibration, motion, displacement, temperature, etc.
via—by way of and/or utilizing.
weight—a value indicative of importance.
wireless—any data communication technique that utilizes electromagnetic waves emitted by an antenna to communicate data (i.e., via an unguided medium), including such data communication techniques as sonar, radio, cellular, cellular radio, digital cellular radio, ELF, LF, MF, HF, VHF, UHF, SHF, EHF, radar, microwave, satellite microwave, laser, infrared, etc., and specifically excluding human voice radio transmissions, the data communication technique having a carrier frequency ranging from about 1 Hz to about 2×10¹⁴ Hz (about 200 terahertz), including all values therebetween, such as for example, about 40 Hz, 6.010 kHz, 8.7 MHz, 4.518 GHz, 30 GHz, etc. and including all subranges therebetween, such as for example, from about 100 kHz to about 100 MHz, about 30 MHz to about 1 GHz, about 3 kHz to about 300 GHz, etc. Wireless communications can include analog and/or digital data, signals, and/or transmissions.

### Note

Still other substantially and specifically practical and useful embodiments will become readily apparent to those skilled in this art from reading the above-recited and/or herein-included detailed description and/or drawings of certain exemplary embodiments. It should be understood that numerous variations, modifications, and additional embodiments are possible, and accordingly, all such variations, modifications, and embodiments are to be regarded as being within the scope of this application.

Thus, regardless of the content of any portion (e.g., title, field, background, summary, description, abstract, drawing figure, etc.) of this application, unless clearly specified to the contrary, such as via explicit definition, assertion, or argument, with respect to any claim, whether of this application and/or any claim of any application claiming priority hereto, and whether originally presented or otherwise:
there is no requirement for the inclusion of any particular described or illustrated characteristic, function, activity, or element, any particular sequence of activities, or any particular interrelationship of elements;
no characteristic, function, activity, or element is “essential”;
any elements can be integrated, segregated, and/or duplicated;
any activity can be repeated, any activity can be performed by multiple entities, and/or any activity can be performed in multiple jurisdictions; and
any activity or element can be specifically excluded, the sequence of activities can vary, and/or the interrelationship of elements can vary.

Moreover, when any number or range is described herein, unless clearly stated otherwise, that number or range is approximate. When any range is described herein, unless clearly stated otherwise, that range includes all values therein and all subranges therein. For example, if a range of 1 to 10 is described, that range includes all values therebetween, such as for example, 1.1, 2.5, 3.335, 5, 6.179, 8.9999, etc., and includes all subranges therebetween, such as for example, 1 to 3.65, 2.8 to 8.14, 1.93 to 9, etc.

When any claim element is followed by a drawing element number, that drawing element number is exemplary and non-limiting on claim scope. No claim of this application is intended to invoke paragraph six of 35 USC 112 unless the precise phrase “means for” is followed by a gerund.

Any information in any material (e.g., a United States patent, United States patent application, book, article, etc.) that has been incorporated by reference herein, is only incorporated by reference to the extent that no conflict exists between such information and the other statements and drawings set forth herein. In the event of such conflict, including a conflict that would render invalid any claim herein or seeking priority hereto, then any such conflicting information in such material is specifically not incorporated by reference herein.

Accordingly, every portion (e.g., title, field, background, summary, description, abstract, drawing figure, etc.) of this application, other than the claims themselves, is to be regarded as illustrative in nature, and not as restrictive, and the scope of subject matter protected by any patent that issues based on this application is defined only by the claims of that patent.

What is claimed is:

1-12. (canceled)

13. A machine-readable medium comprising machine-implementable instructions for activities comprising:
causing a communication with an emergency services provider from a communication device, the notification responsive only to an automatic determination that a user has invoked a predetermined pattern of one or more of a plurality of active components comprised by the communication device, each of the plurality of active components having a function when invoked individually that is not directed toward placement of any call, wherein the communication device transmits data comprising at least one of sound data, and image data, wherein the data is collected and transmitted by the communication device without the user acting further other than invoking the predetermined pattern of one or more of the plurality of active components.

14. The machine-readable medium of claim 13, wherein:
the predetermined pattern of one or more of the plurality of active components results from the user associating touches of the predetermined pattern of one or more of the plurality of active components with a certain desired action

15. The machine-readable medium of claim 13, wherein:
the user defines the predetermined pattern of one or more of a plurality of active components.

16. The machine-readable medium of claim 13, wherein:
the user changes the predetermined pattern of one or more of a plurality of active components.

17. A machine-readable medium comprising machine-implementable instructions for activities comprising:
causing a communication with an emergency services provider from a communication device, the notification responsive only to an automatic determination that a user has invoked a predetermined pattern of one or more of a plurality of active components comprised by the communication device, each of the plurality of active components having a function when invoked individually that is not directed toward placement of any call, wherein the communication device transmits data comprising medical information, an audio message from the user, and video information regarding the user, wherein the data is collected and transmitted by the communication device without the user acting further other than invoking the predetermined pattern of one or more of the plurality of active components.

18. The machine-readable medium of claim 17, wherein:
the predetermined pattern of one or more of the plurality of active components results from the user associating touches of the predetermined pattern of one or more of the plurality of active components with a certain desired action

19. The machine-readable medium of claim 17, wherein:
the user defines the predetermined pattern of one or more of a plurality of active components.

20. The machine-readable medium of claim 17, wherein:
the user changes the predetermined pattern of one or more of a plurality of active components.
